(19) United States
(12) Patent Application Publication
(10) Pub. No.: US 2007/0216992 A1
(43) Pub. Date: Sep. 20, 2007

(54) Light guide plate luminance mixing structure

(75) Inventors: Gwo-Juh Tzeng, Jhongli City (TW); Shu-Sheng Chen, Jhongli City (TW); Chun Pin Chang, Jhongli City (TW); Yeh-Hsun Tseng, Jhongli City (TW)

Correspondence Address: TROXELL LAW OFFICE PLLC, SUITE 1404, 5205 LEESBURG PIKE, FALLS CHURCH, VA, 22041, US

(73) Assignee: Taiwan Nano Electro-Optical Technology Co. , Ltd.

(21) Appl. No.: 11/654,039

(22) Filed: Jan. 17, 2007

(30) Foreign Application Priority Data
Jan. 27, 2006 (TW) 95201898

(51) Int. Cl. H01S 3/00

(52) U.S. Cl. 359/333

(57) ABSTRACT

A light guide plate luminance-mixing structure includes a light guide plate containing a light input plane, a bottom crossing the light input plane, and a light output plane opposite to the bottom, and multiple point light sources being disposed in relation to one side of the light input plane; multiple luminance-mixing structures provided on the light guide plate being divided into two sets by a central line extending from the light input plane with both sets being different from each other to allow different volumes of light emitted from both sides of the central line with the volumes adjustable depending on the arrangement of point light sources to promote consistent luminance for effectively correcting the inconsistent distribution of luminance as found with the prior art

### BACKGROUND OF THE INVENTION

(a) Field of the Invention

The present invention is related to a light guide plate luminance mixing structure, and more particularly, to one that is adapted to a light plate in a side light emitting display to correct the inconsistently distribution of luminance of a backlight module of the prior art.

(b) Description of the Prior Art

Whereas the configuration of a direct or side emitting backlight module may be selected for a liquid crystal display (LCD) generally applied in an information unit, Taiwan Patent Application No. 01112454 published on Nov. 21, 2001 teaches a side emitting backlight module configuration as illustrated in FIGS. 1 and 2 of the accompany drawings. Wherein, as illustrated, an area on one end of a light guide plate 30 relates to a light input plane 31 and the front area of the light guide plate 30 relates to an light output plane 32; the stream of light emitted from a light source 20 enters into through the light input plane 31 and outputted from the light output plane 32 of the light guide 30 to achieve the display results of the light source 20.

The light source 20 is comprised of two light emitting portions 22. A light emitting diode (LED) is disposed in each light emitting portion 22; the light input plane 31 of the light guide plate 30 and the light source are opposite to each other; multiple cone-shaped cutting slots 40 are disposed in an area directly opposite to both light emitting portions 22; and each cutting slot 40 is divided into two structures of light diffusion portion 41.

The stream of light emitted form the LED 21 enters into the light guide plate 30 through a light receiving area 311 provided at where in relation to the light emitting portion 22; since the cone-shaped cutting slot 40 is provided with two inclined surfaces relatively to the light input plane 31 and the stream of light is emitted at a given angle into the light diffusion portion 41 and further enters when diffused into the light guide plate 30, thus to promote the consistent luminance of the light leaving the light output plane 32 of the light guide plate 30.

Whereas the LED 21 relates to a point light source, the stream of light it emits may be divided into a first light emitting area A and a second light emitting area B by the central line of the LED 21; the light infusion portions 41 is divided into a first and a second light diffusion members 411, 412 respectively corresponding to the first and the second light emitting areas A, B; both of the first and the second light diffusion members 411, 412 are identical to each other (i.e., having the same cutting slots recessed in the light input plane and arranged in continuum; and the same depth of the cutting slot). Accordingly, the light output volume delivered by the light source of the LED 21 respectively passing through the first and the second diffusion members, 411, 412 and then formed in the first and the second light emitting areas A, B is the same. However, judging from the preferred embodiment as illustrated of the prior art, the spacing H1 between both LEDs 21 is smaller that H2 the distance between each LED 21 and its respective distance from the side of the light guide plate 30 resulting in that the luminance between both LEDs 21 is emphasized and thus gets brighter with darker sides of the light guide plate 20. Consequently, the light emitted becomes inconsistent in luminance.

### SUMMARY OF THE INVENTION

The primary purpose of the present invention is to provide an improved structure of a light guide plate luminance mixing structure that allows consistent emission of stream light passing through the structure to promote the consistence of the light emission of the light emitted so to effectively correct the inconsistent distribution of luminance of the backlight module of the prior art.

To achieve the purpose, the light guide plate includes a light input plane, a bottom intersecting with the light input plane, a light output plane in opposite to the bottom, and multiple point light sources disposed on one side in relation to the light input plane. Wherein, multiple light mixing structures are disposed on the light input plane and are divided into a first and a second sets by the central line extending from the point light source; each of both sets of the light mixing structure contains multiple light mixing devices; and the arrangement mode of those multiple light mixing devices respectively from the first and the second light mixing structures differs from each other so that the light output volume varies between both sides of the central line extending from the point light source; and as the light output volume respectively from both sides of the central line extending from the point light source varies, the light output volume may be adjusted depending on the arrangement of the point light sources.

### BRIEF DESCRIPTION OF THE DRAWINGS

FIG. 1 is a schematic view showing a structure of a backlight module of the prior art.

FIG. 2 is a schematic view showing a structure of a light guide plate of the prior art.

FIG. 3 is a perspective view of a first preferred embodiment of the present invention.

FIG. 4 is a schematic view showing a structure of the first preferred embodiment of the present invention.

FIGS. 5(A), 5(B), and 5(C) are schematic views showing a second preferred embodiment of the present invention.

FIG. 6 is a schematic view showing a structure of a third preferred embodiment of the present invention.

FIG. 7 is a schematic view showing a structure of a fourth preferred embodiment of the present invention.

FIG. 8 is a schematic view showing a structure of a fifth preferred embodiment of the present invention.

FIG. 9 is a schematic view showing a structure of a sixth preferred embodiment of the present invention.

FIG. 10 is a schematic view showing a structure of a seventh preferred embodiment of the present invention.

FIGS. 11(A), 11(B), 11(C) are schematic views showing a structure of an eighth preferred embodiment of the present invention.

FIGS. 12(A) and 11(B) are schematic views showing a structure of a ninth preferred embodiment of the present invention.

FIGS. 13(A) and 13(B) are schematic views showing a structure of a tenth preferred embodiment of the present invention.

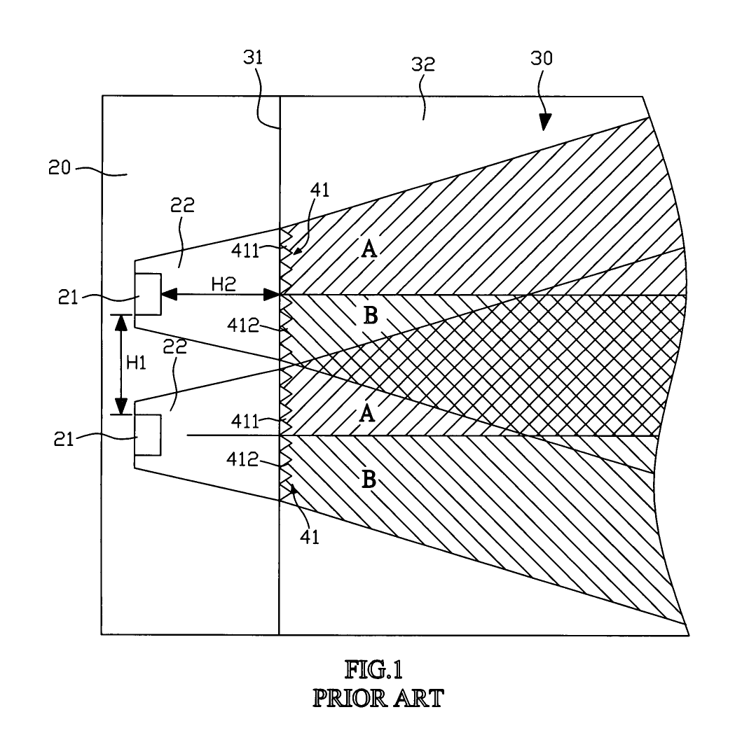

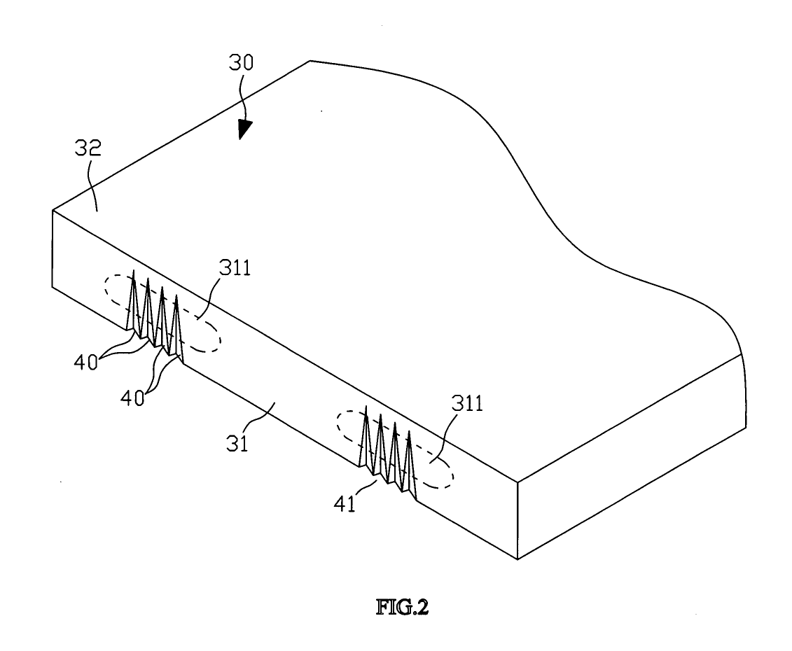

### DETAILED DESCRIPTION OF THE PREFERRED EMBODIMENTS

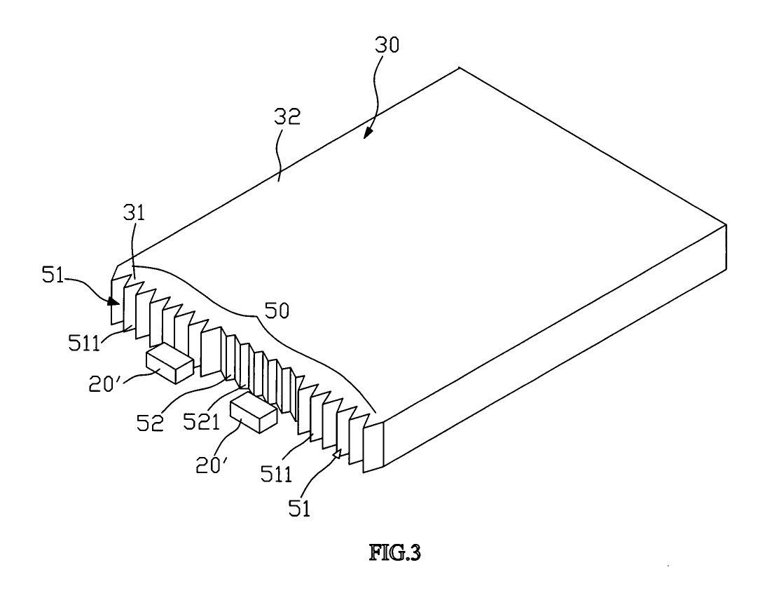

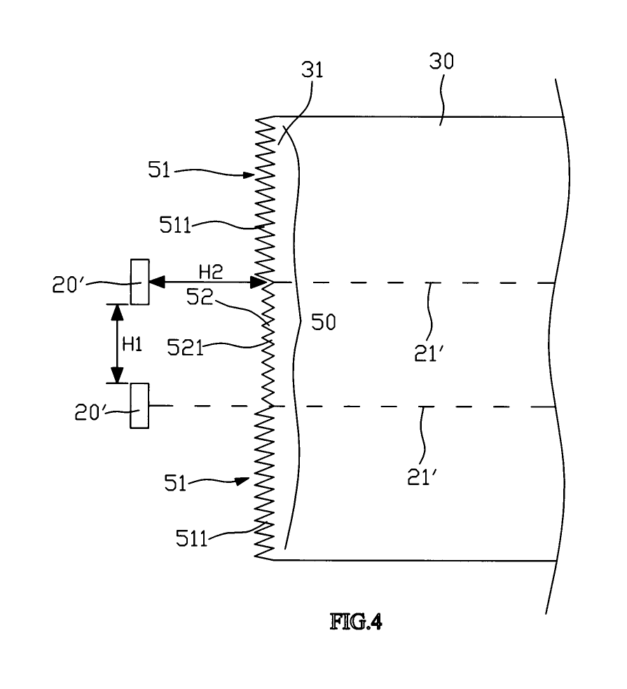

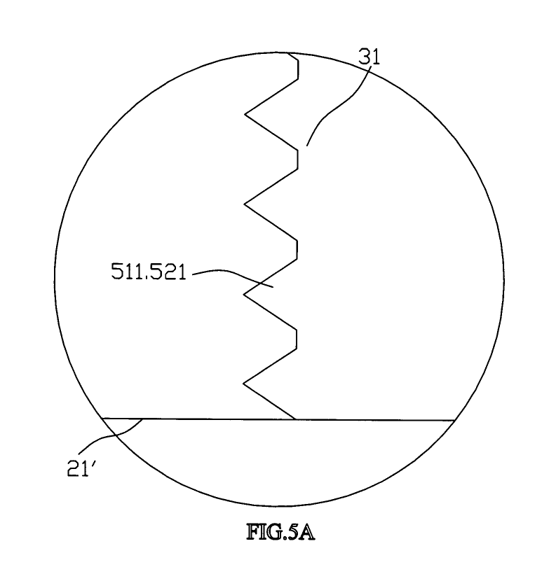

A light guide plate luminance mixing structure of the present invention is essentially related an improved structure of the light guide plate within the configuration of a side emitting backlight module. As illustrated in FIGS. 3 and 4, one end of a light guide plate 30 is related to a light input plane 31 with its front side related to a light output plane 32, and multiple point light source 20′ are disposed in relation to one side of the light input 31. Each point light source 20′ maybe related to a light emitting diode. Accordingly, the stream of light enters from the light input plane 31 and leaves from the light output 32 on the front surface of the light guide plate 30 to achieve the purpose of light display effects.

Multiple luminance mixing structures 50 are disposed on the light input plane 31. By extending the central line of each point light source 20′, those luminance mixing structures 50 are divided into two sets, the first set 51 and the second set 52 of light luminance mixing structures with each set contains multiple luminance mixing devices 511, 521 provided in different patterns so that the light output volumes respectively emitted from both sides of the central line extending from the point light source 20′ are different from each other. In the first preferred embodiment as illustrated, each luminance mixing device 511, 521 is related to a cutting slot protruding from the light input plane 31 and all the luminance mixing devices 511, 512 are continuously arranged with only a difference in that the depth of each luminance mixing device 511 is greater than that of each luminance mixing device 512. When the spacing Hi between two abutted point light source 20′ is smaller than the distance H2 between each light emitting diode 21 and the side of the light guide plate 30, the light output volume is adjusted by taking advantage of both sets of luminance mixing structures 51, 52 of different patterns for the light output volume emitted from where between two abutted point light sources 20′ becomes identical with that from both sides of the central line 21′ extending from each point light 20's to effectively adjust the darker or brighter area and upgrade the luminance consistency of the stream of light emitted.

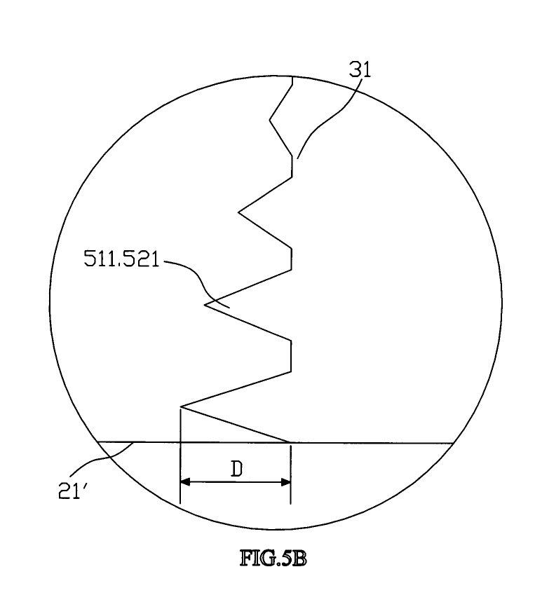

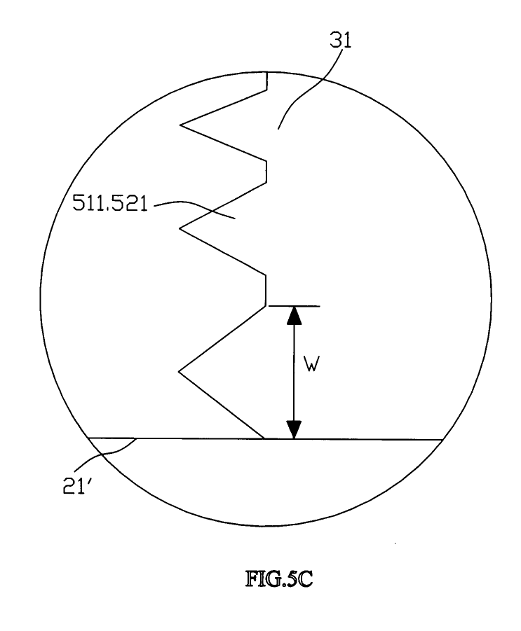

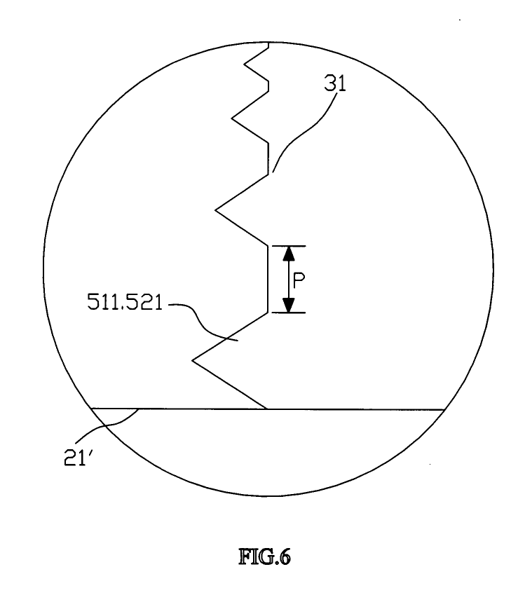

Different arrangement maybe provided for those luminance-mixing devices 511, 521 as illustrated in the following preferred embodiments. Referring to FIG. 5(A), each luminance-mixing device 511, 512 is related to a cutting slot protruding from the light input plane 31. The inclination of the angle of incidence of the light received by the light luminance device 511, 521 becomes greater as the light luminance device 511, 521 is getting farther away from the point light source 20′; therefore, for the deeper luminance mixing device 511, 512, its bottom gets darker due to the inclination of the angle of incidence of light. Consequently, the depth D of the luminance-mixing device 511, 512 gradually gets shorter for the device 511, 512 that is farther away from the central line 21′ as illustrated in FIG. 5(B). Meanwhile the width W of the luminance mixing device 511, 521 also diminishes towards both sides of the central line 21′ as illustrated in FIG. 5(C). It is preferred that the luminance-mixing device 511, 521 in the least width or depth is disposed at where closer to the central line 21′ to promote the consistence of the luminance of the stream of light emitted. The spacing P between two abutted luminance mixing devices 511, 512 may be fixed or indicate gradient variances as illustrated in FIG. 6 while the luminance-mixing devices 511, 521 provided with the greatest spacing P are provided at where closer to the central line 21′ of the point light source.

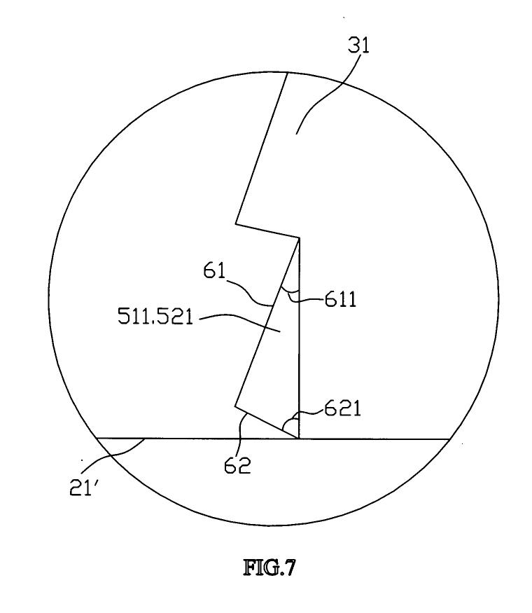

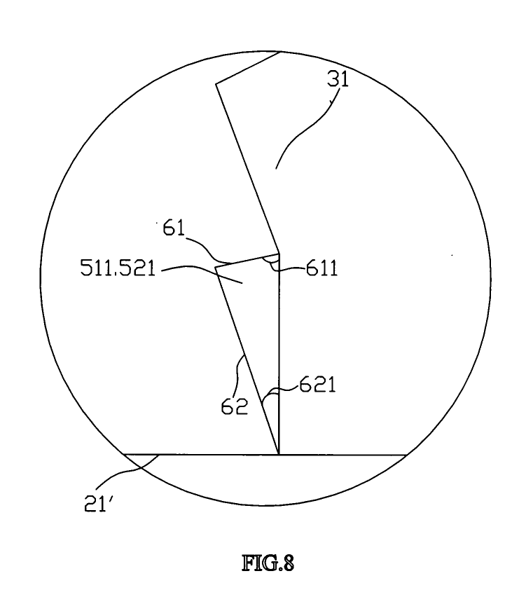

Now referring to FIG. 7, the luminance-mixing device 511, 521 is also provided in the form of a cutting slot while a first bevel edge 61 and a second bevel edge 62 opposite to each other are given to each luminance-mixing device 511, 521 to respectively define a first included angle 611 and a second included angle 621 in different degrees with the light input plane 31. Both of the included angles 611, 621 may indicate gradient variances with the luminance mixing device 511, 521 having the first included angle 611 in the least degree and the second included angle 621 in the greatest degree disposed at where closer to the central line 21′; or alternatively, as illustrated in FIG. 8, the luminance mixing device 511, 521 having the first included angle 611 in the greatest degree and the second included angle 621 in the least degree is disposed at where closer to the central line 21′.

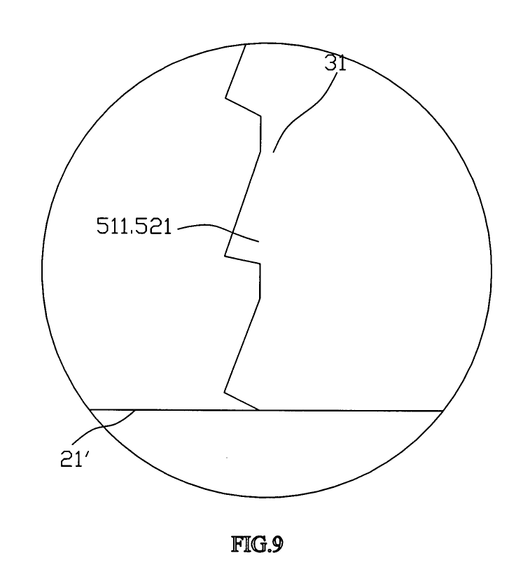

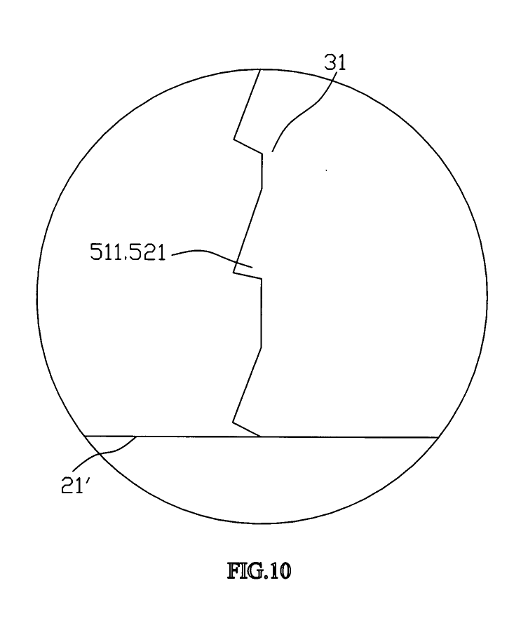

Disregarding that either included angle 611, 621 may present gradient variance, multiple luminance-mixing devices 511, 521 may be continuously arranged without interruption as illustrated in FIG. 7; or with a fixed spacing as illustrated in FIG. 9; or with a gradient variance as illustrated in FIG. 10 and the luminance-mixing devices 511, 521 having the greatest spacing are disposed at where closer to the central line 21′.

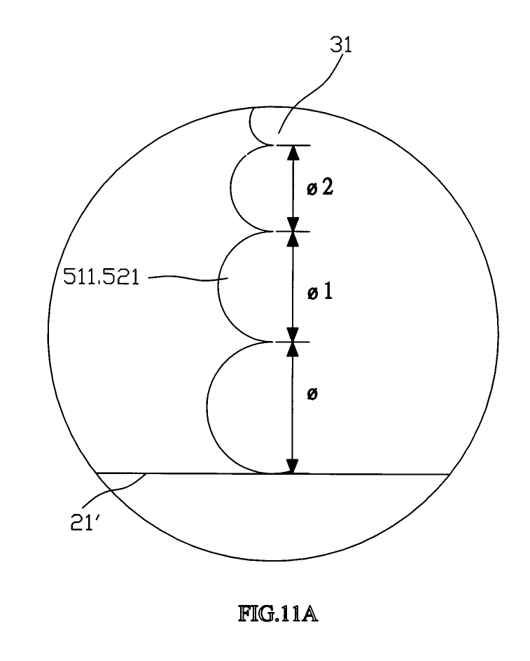

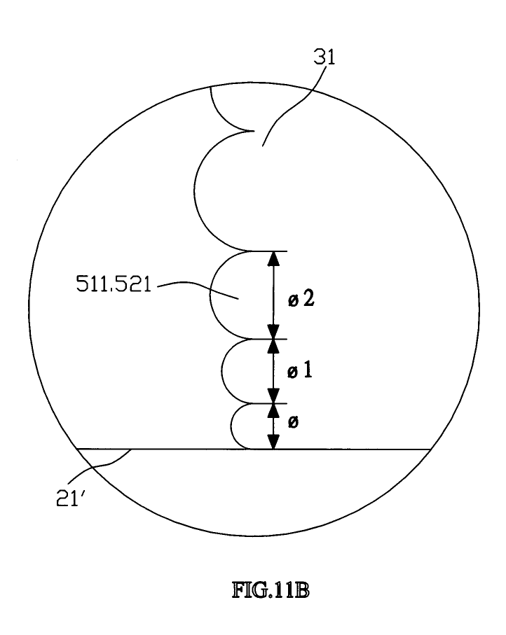

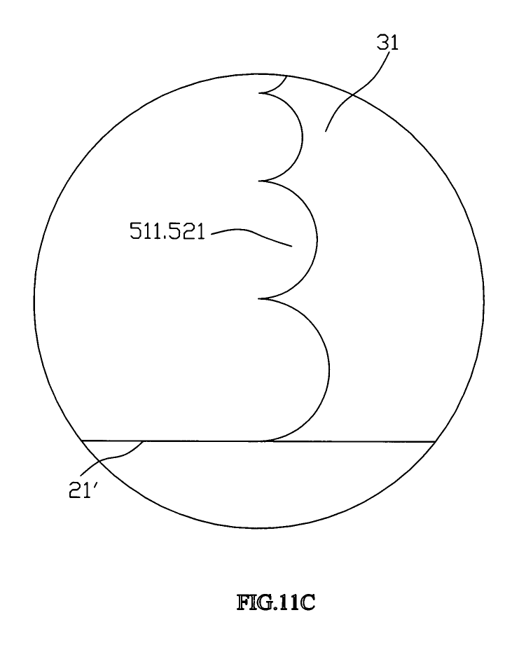

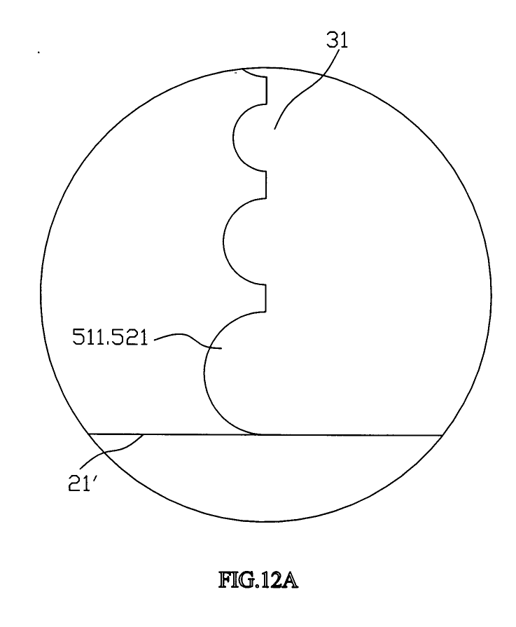

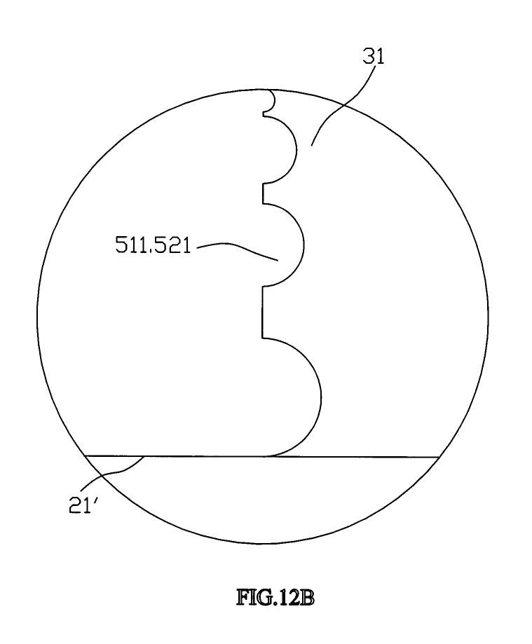

Each luminance-mixing device 511, 512 may be related to a structure either protruding from or recessing into the surface of the light input plane 31 in an arc form as illustrated in FIG. 11(A). Wherein, each luminance-mixing device 511, 521 protrude from the surface of the light input plane 31 with their arcs or diameters Ø indicating gradient variances, the luminance-mixing devices 511, 521 disposed at where closer to the central line 21′ are provided with the greatest arc or diameters Ø, i.e., Ø>Ø1>Ø2, and the diameter Ø gradually diminishes towards both sides of the central line 21′; or alternatively, as illustrated in FIG. 11(B), the luminance-mixing devices 511, 521 disposed at where closer to the central line 21′ are provided with the least arc or diameter Ø, i.e. Ø<Ø1<Ø2. Accordingly, the point light source with its inherited light diffusion nature compromises the change of the diameter of each luminance-mixing device 511, 521 to allow the corners of the light guide plate to receive more streams of light and to promote the overall consistence of the luminance emitted from the light output plane for effectively correcting the inconsistent distribution of luminance as found with the prior art. Each luminance-mixing device 511, 521 may be recessed into the light input plane as illustrated in FIG. 11(C). Either those luminance-mixing devices 511, 521 protrude from or recess into the light input plane 31, they may be continuously arranged without interruption as illustrated in FIGS. 11(A), 11(B), and 11(C); or arranged with a fixed spacing as illustrated in FIG. 12(A), or with gradient variances and having the luminance-mixing devices 511, 521 giving the greatest spacing to be disposed at where closer to the central line 21′ as illustrated in FIG. 12(B).

It is to be noted that though each of those preferred embodiments of the present invention given above discloses multiple luminance-mixing structures disposed on a light input plane of a light guide plate that may destroy the route of the light travels, the design of each luminance-mixing device is not constant since gradient variances are allowed to arc, diameter, width, depth, spacing, or included angle; and the luminance-mixing structures respectively provided on both sides of a central line extending from the point light source may be given in different patterns according to the arrangement and combination disclosed in those preferred embodiments of the present invention to effectively adjust the luminance in the darker or brighter area depending on the individual light source with the ultimate objective of promoting the luminance consistence of the light emitted.

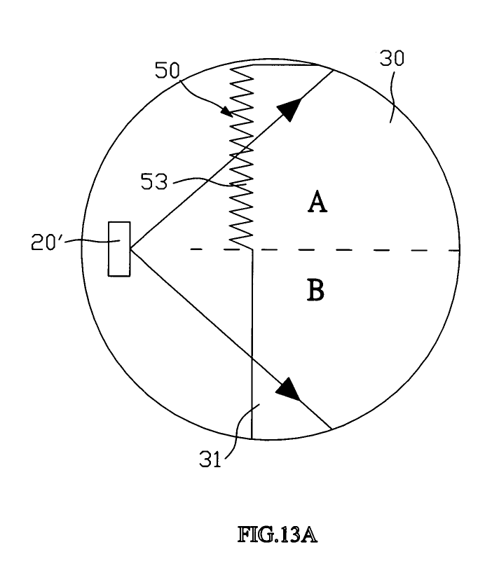

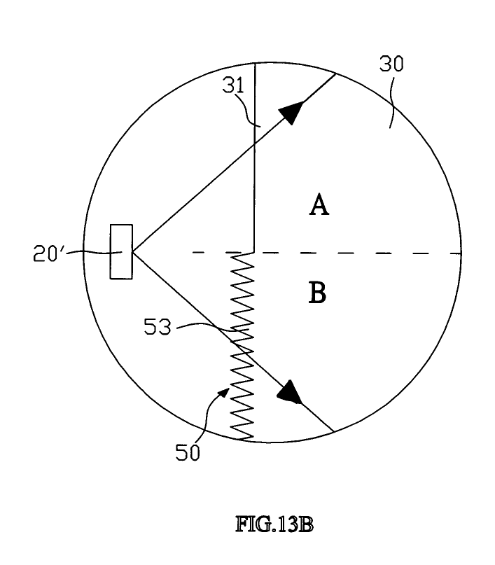

Furthermore, the central line extending from the point light source on the side of the light input plane divides the light input plane 31 into a first light emitting area A and a second light emitting area B. Those luminance-mixing devices maybe all disposed in one light emitting area with the other area to indicate a plane for both light-emitting areas A, B to deliver light in different volumes. In practice, as illustrated in FIG. 13(A), on one side of the light input plane 31, it is divided into the first and second light emitting areas A, B by the central line extending from the point light source; a set of luminance-mixing structure 50 containing multiple luminance-mixing devices 53 in a form as that described in any preferred embodiment give above is provided in the first light emitting area A; and the second light emitting area B is related to a plane without any luminance-mixing device 53 disposed thereon. Alternatively as illustrated in FIG. 13 (B), a set of luminance-mixing structure 50 containing multiple luminance-mixing devices 53 in a form as that described in any preferred embodiment give above is provided in the first light emitting area B; and the second light emitting area A is related to a plane without any luminance-mixing device 53 disposed thereon to achieve the same purpose of delivering different volumes of light output respectively from both sides of the central line of the point light source to effectively adjust the luminance in the darker or brighter area depending on the individual light source with the ultimate objective of promoting the luminance consistence of the light emitted

The prevent invention provides an improved structure of a luminance mixing adapted to a side emitting backlight module, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A light guide plate luminance-mixing structure includes a light guide plate containing a light input plane, a bottom crossing the light input plane, and a light output plane opposite to the bottom; multiple point light sources disposed in relation to one side of the light input plane; multiple luminance-mixing structures disposed on the light input plane, each luminance-mixing structure being divided into a first and a second sets by a central line extending from the point light source; each set of luminance-mixing structures containing multiple luminance-mixing devices; two sets of those luminance-mixing devices being different from each other; and light output volumes emitted from both sides of the central line being also different from each other.

2. The light guide plate luminance-mixing structure as claimed in claim 1, wherein the luminance-mixing device is either protruding from or recessing into the surface of the light input plane.

3. The light guide plate luminance-mixing structure as claimed in claim 1, wherein each luminance-mixing device is related to an arc structure.

4. The light guide plate luminance-mixing structure as claimed in claim 1, wherein the arc or diameter of each luminance device indicates gradient variances with the luminance-mixing device having either the greatest or the least arc or diameter being disposed at where closer to the central line of the point light source.

5. The light guide plate luminance-mixing structure as claimed in claim 1, wherein those multiple luminance-mixing devices are continuously arranged without interruption.

6. The light guide plate luminance-mixing structure as claimed in claim 1, wherein the spacing between any two abutted luminance-mixing devices is fixed.

7. The light guide plate luminance-mixing structure as claimed in claim 1, wherein the spacing between two abutted luminance devices indicates gradient variances with the luminance-mixing device having the greatest spacing being disposed at where closer to the central line of the point light source.

8. The light guide plate luminance-mixing structure as claimed in claim 1, wherein the spacing between two abutted luminance devices indicates gradient variances with the luminance-mixing device having the least spacing being disposed at where closer to the central line of the point light source.

9. The light guide plate luminance-mixing structure as claimed in claim 1, wherein the luminance-mixing device is provided in a form of a cutting slot.

10. The light guide plate luminance-mixing structure as claimed in claim 9, wherein each luminance-mixing device is provided with a first and a second bevel edges opposite to each other to respectively define a first and a second included angles in different degrees with the light input plane.

11. The light guide plate luminance-mixing structure as claimed in claim 10, wherein the first and the second included angles of each luminance-mixing device indicates gradient variances with the luminance-mixing device having the greatest first included angle and the least second included angle being disposed at where closer to the central line of the point light source.

12. The light guide plate luminance-mixing structure as claimed in claim 10, wherein the first and the second included angles of each luminance-mixing device indicates gradient variances with the luminance-mixing device having the greatest least included angle and the greatest second included angle being disposed at where closer to the central line of the point light source.

13. The light guide plate luminance-mixing structure as claimed in claim 9, wherein each luminance-mixing device is provided with a first and a second bevel edges opposite to each other to respectively define a first and a second included angles in a same degree with the light input plane.

14. A light guide plate luminance-mixing structure includes a light guide plate containing a light input plane, a bottom crossing the light input plane, and a light output plane opposite to the bottom; multiple point light sources disposed in relation to one side of the light input plane; one side of the light input plane being divided into a first and a second light emitting areas by the central line extending from the point light source; a luminance-mixing structure being disposed in either area with another area indicating a plane; and volumes of light respectively emitted from both light emitting areas being different from each other.

15. The light guide plate luminance-mixing structure as claimed in claim 1, wherein the point light source is related to a light emitting diode.

16. The light guide plate luminance-mixing structure as claimed in claim 14, wherein the point light source is related to a light emitting diode.
